(19) United States
(12) Patent Application Publication
(10) Pub. No.: US 2026/0018847 A1
(43) Pub. Date: Jan. 15, 2026

(54) SELF-RECOVERING LASER SAFETY SYSTEM WITH AUTOMATIC DIAGNOSIS SYSTEM

(71) Applicant: Wi-Charge Ltd., Rehovot (IL)

(72) Inventors: Ortal Alpert, Ness Ziona (IL); Lior Golan, Ramat Gan (IL); Nir Simon, Kibbutz Ein Hashofet (IL); Ori Mor, Tel Aviv (IL); Eli Zlatkin, Tel Aviv (IL); Alexander Slepoy, Chandler, AZ (US); Yan Rosh, Tel Aviv (IL)

(73) Assignee: Wi-Charge Ltd., Rehovot (IL)

(21) Appl. No.: 18/881,827

(22) PCT Filed: Jul. 6, 2023
(86) PCT No.: PCT/IL2023/050700

§ 371 Date: Jan. 7, 2025

(30) Foreign Application Priority Data
Jul. 7, 2022 (IL) 294616

(51) Int. Cl. H01S 3/00; H01S 3/10; H01S 3/101; H02J 13/00; H02J 50/30; H02J 50/60

(52) U.S. Cl. CPC H01S 3/0014; H01S 3/10038; H01S 3/101; H02J 13/00004; H02J 50/30; H02J 50/60

(57) ABSTRACT

A diagnostic system for a high power laser system, which detects and responds to malfunctions in interlocks of the laser safety system. A fault detected in any interlock circuit mandates a limitation in the operating conditions of the laser, or even a shutdown. In order to distinguish between transient faults, arising typically from ambient conditions, and more permanent faults, arising from faulty components or circuits, and which require external intervention to rectify, the system uses a database of possible fault classifications to determine the likely type of fault. If the fault is likely transient, the laser is maintained in a reduced power state, until one or more temporary interlocks are applied as backup for the failed interlocks, so that the system can be repeatedly tested for fault correction at full power output. Once the fault recovers, the backup interlocks may be disabled and the system returned to full operation.

### FIELD OF THE INVENTION

The present disclosure describes technology related to the field of safety systems in laser systems, especially to the issue of the assurance of the functionality of such safety systems.

### BACKGROUND

A high power laser system, to which general users without specific training in laser safety have access, should be protected by a number of safety interlocks, each of which is configured so that it provides a warning, or performs a corrective action, should a condition arise that would enable the system user, a bystander or even an animal or inanimate object to have access to, or come into contact with the high power, and hence hazardous, laser beam. Such interlocks together constitute part of a safety system, also known as an automatic emission control, and a typical laser system could have several interlocks, each detecting a particular safety threat which could occur. Without the interlocks, users could have access to a hazardous laser beam, or the beam could be released into the space around the laser system. Interlocks can be understood to be the circuits including sensors, logic elements and output systems, whose function is to ensure that the conditions under which the laser system is operating are safe. As such, they provide warnings or corrective action for external threats. Several such safety systems have been described in a number of patents and patent applications, including for instance, U.S. Pat. No. 11,356,183 for ‘System for Optical Wireless Power Supply’, U.S. Pat. No. 9,866,075 for ‘System for Optical Wireless Power Supply’, U.S. Pat. No. 11,322,991 for ‘Flexible Management System for Optical Wireless Power Supply’, U.S. Pat. No. 11,070,298 for ‘Fail-Safe Optical Wireless Power Supply’ and Patent Application IL 291878 for ‘System for Laser Power Transmission in Environments with Gas Heating or Cooking’, all assigned to the present applicant.

Laser safety systems should, in some cases, be redundant, in the sense that there should be at least two interlocks protecting against the same safety threat, such that if one interlock fails to operate, there will always be at least another back-up interlock to protect the user or the environment from the threat generated by the safety system failure. Some prior art systems do incorporate such redundancy provisions. However, even with built-in redundancy, there could be situations in which malfunctions of the interlocks occur, or combinations of such malfunctions occur, which would render the safety system as inadequate, or even inoperative.

The disclosures of each of the publications mentioned in this section and in other sections of the specification, are hereby incorporated by reference, each in its entirety.

### SUMMARY

The present disclosure attempts to provide novel systems and methods that overcome at least some of the disadvantages of prior art systems and methods. In particular, the present disclosure provides a supervisory or diagnostic system, which monitors the functionality of the safety interlocks themselves, to ensure the detection of a situation in which a malfunction of an interlock, or combinations of such interlock malfunctions, occurs. Such a malfunction would render the safety system as inadequate, or even inoperative. Such a fault detection mechanism or diagnostic system, is known from that part of ISO 13849 which is intended to give guidance in the design and assessment of machinery control systems, and should issue a warning and take positive safety action to control operation of the laser system in the event of such a failure of the safety system. Additionally, the diagnostic system should be able to execute and monitor a method of safely returning the laser system to normal operation, if the diagnostic system determines that the interlock fault arises from a transient fault, which may subside by itself with reversion of the conditions or environmental surroundings of the laser system to their normal levels.

The present disclosure thus describes new exemplary systems for a diagnostic system, which detects and responds to malfunctions in the sensors, components or overall circuits of the various interlocks of a laser safety system, such that in the event of a fault occurring in one of the interlock circuits, the diagnostic system can instruct a change in the operating conditions of the laser, or even to shut it down, in order to prevent exposure of users to the potentially dangerous laser beam. Therefore, in those situations where the reliability of the laser safety system may be compromised because of one or more interlock failures, which, had they been working correctly, would have caused the safety system to take the necessary safety actions, the diagnostic system performs the functions, or sometimes, similar functions, which the laser safety system itself should have undertaken. Thus, whereas an interlock system would typically perform these actions of protecting the users or the environment only when a hazard occurs, the diagnostic system performs these actions in response to a sensor or component or circuit malfunction, and not in response to a hazard, as the safety system should have done were it not for the detected interlock failures. The diagnostic system is not therefore a safety system in itself, but rather a system that checks that all of the interlocks which themselves constitute the safety system, are operative and fault-free. The diagnostic system generally performs this by monitoring the sensors, circuit outputs and measurements used to input to the various interlocks, as well as sensors indicative of the good working order of the logic elements of the safety system. When a monitor reveals a value outside of an acceptable range, or no output at all, the diagnostic system indicates a system fault, and operates to ensure continued safety of the laser system. One method by which the diagnostic system can achieve this, is by ensuring that the laser system switches to a safe state, with a limited output that is intended to prevent any beam transmissions that could be harmful, and optionally and additionally, ensuring that the laser system is prevented from switching to its high power normal state. The circuits, software or control elements that achieve such an outcome, can also be termed safety interlocks, since they provide inputs to the laser system to ensure its user safety.

Malfunctions in the interlock system can be divided into two general types. Some such malfunctions may be caused by failed physical components. Some examples of such component failures could include a burnt-out sensor or electronic components such as a transistor, short circuits, breaks in wiring, or damaged reflectors or windows. Such failures are typically permanent, at least until repaired, and the laser system should be prevented from continuing operation until the component problem has been solved generally by means external to the system. Thus for instance, a damaged or broken mirror will remain in that state until a technician repairs or replaces the mirror. Alternatively, in those circumstances where they exist, the problem remains until an automatic repair system does some operation, such as automatic self-cleaning of an optical surface, to repair surface degradation.

Others malfunctions may be caused by transient events, such as environmental conditions including, for instance, temperature, dust, humidity, radiation, electronic or acoustic noise or vibrations, and other effects, which cause a temporary fault reading, or temporarily prevent the detection system, the logic system or the switch from operating, and hence temporarily prevent the interlock system from functioning properly. These malfunctions are often related to external influences on the system. Some examples of such external influences include an excessively high temperature in a parameter measurement sensor, or in the laser or its power supply, or of a photovoltaic cell, or a sensor blinded by sunlight, or electronic noise interference, gamma particles emitted from the sun, the effect of a transient external magnetic field on a circuit or component, or an external mechanical shock, resulting in vibratory movement of a mirror, though not damaging or moving it permanently, or any such similar external influence.

It is generally difficult for the diagnostic system to determine whether a fault event is transient or permanent. Thus, for instance, components may be influenced by external conditions, until they may reach a physical state outside of their working specifications, such as being exposed to temperatures that are too high or too low. Such an event may be characterized as a transient event, since when the temporary conditions have passed, the component will return to operate correctly and to fulfilling its circuit function.

The diagnostic system is configured to monitor the operational state of the interlocks, and to respond when it detects a problem in an interlock sufficiently serious that the interlock is considered to have failed to provide its warning signal. The default response is to bring the laser system to a safe state, typically by reducing the laser power, or by turning it off completely, and, even when in the safe state, to preclude the laser system from going into a state that may involve hazards. Once in the safe state, when the detected problem is a transient fault, there arises the need to determine if the transient fault has passed. Since laser power may be required to detect if the transient problem is over, the problem then arises about how to bring the laser system back into safe operation in a situation where the diagnostic system has revealed that there is at least one faulty interlock which may or may not be functioning to provide a hazard warning. Any attempt to bring the laser system back into operation may be accompanied by a safety problem. Without the correctly functioning interlock, there is no certainty that the laser system would operate safely, and without turning the laser on, there may be no way to ensure that the transient problem has passed.

In order to overcome this problem, the presently described diagnostic systems use a novel configuration in which a procedure is adopted to use a second and independent system checking and control procedure, to operate as a back-up interlock. This could be a temporary interlock, whose function is only to ascertain that the laser system is in a safe state, and can begin operation again, even though the initial primary interlock, which warned of the fault in the laser system, is not providing the permission to begin operation of the laser system again. Once the main interlock is cleared as operating correctly, since its fault situation has subsided or has been repaired, the backup interlock procedure can be abandoned and the main interlock may be relied upon to perform its function again.

Interlocks can thus be classified in two groups. The main interlocks are typically those which analyze the operating characteristics of the system, and provide a warning indication and instigate action, if the system fault is such as to enable the transmission of a beam hazardous to the users or the surrounding environment. Such interlocks, termed complex interlocks because of their generally more sophisticated operational modes, include such interlocks as the power accounting system which checks the difference between transmitted beam power and received beam power, to calculate whether an intrusion into the beam has occurred. Other interlocks, such as those, for instance based on the measurement of certain operating parameters of the laser power supply, such as the laser current drawn, or based on monitoring of the beam level reflected from a receiver, and others, are also direct interlocks, whose function is generally to directly monitor the correct operation of the system, and to intervene should a hazardous situation arise.

Other types of interlock are those which, once a system fault has been detected, are used to ensure that even under the system fault, when one or more main interlocks may be inoperative, the laser is prevented from operating in a manner which would generate hazardous radiation. Such interlocks are thus temporary interlocks, implemented only so long as the main interlocks are inoperative because of a system fault. These interlocks can therefore be termed back-up interlocks, or simple interlocks, since their functionality is generally less complex than the main interlocks

There are a number of procedures which can be used as simple and temporary interlocks. Of these procedures, two are particularly simple to apply, since they only involve control of the laser beam power exposure, without the need for any other parameter or system component manipulation. The first simple interlock involves the diagnostic system imposing a limit on the power at which the laser is allowed to operate, to a level at or below the permissible or accessible exposure limit (AEL), such that even if the original faulty part of the main interlock system is still inoperative, a dangerous situation will not be generated. The second temporary interlock may be implemented by limiting the time that the laser is allowed to emit its beam to a duration less than the integrated exposure limit allowed. A combination of both of these temporary interlocks can, of course, be used. One or both of these temporary interlocks, or one or more alternative temporary backup interlocks, can be applied until there is received in the diagnostic system, a confirmation that the event which caused the primary interlock to show a fault, has been solved. Once such a situation is achieved, operation of the laser system can be returned to its full original level. Other alternative temporary backup interlocks can use a number of functions, such as fast scanning the laser beam over a patterned array such that even if the laser is emitting at a high power, it will not expose an area on an intruding person for a time long enough to enter an excessive exposure situation. Another back-up interlock could be the activation of a beam blocking function, which absorbs the beam. Yet another back-up interlock could be the attenuation or diffusion of the laser beam power, such that it falls below the allowed power limit. Finally, a beam control function could be used to direct the beam into an empty region, where it is known that human access is unavailable.

These simple or back-up interlocks are used to ensure that in fault conditions, the laser can operate, but in a controlled low output state, or in a configuration that does not expose the user or any point of the environment to a laser power for a duration longer than that allowed for the aforesaid laser beam power. Under those conditions, the fault can be investigated and either repaired or allowed to return to normal by itself, as will be explained below.

If no confirmation of the return of the system to correct operation is received by the diagnostic system, the laser is precluded from emitting at its higher power level. This is the procedure that would be used for permanent, or, more accurately, non-transient faults, such as damaged components, short circuited or open circuited electronic functions, damaged mirrors, and the like, which will not correct themselves until the problem causing the fault has been repaired. Once this has been done, generally by a maintenance person, a confirmation signal should be generated by the maintenance person that the fault has passed, and the laser system may be restarted on the basis of this confirmation signal.

The diagnostic system must operate even if there are multiple interlocks in operation, such as, for instance, if there is at least one additional interlock providing a safety feature besides the interlock currently being tested.

Such a safety diagnostic system should be an essential adjunct to the safety system of any high-power laser system, since without such a diagnostic system, the laser system would desist operation for numerous, apparently trivial occurrences, such as a missed digit in a computer routine because of a noise spike in the power supply. In a laser wireless charging system, where there is no need to charge or replace batteries, and which should be capable and expected, after being set up, to run for extended periods without further attention, the need for a safety system that self-recovers from transient events is important. The safety diagnostic systems of the present disclosure are intended to achieve such reliable safety systems for a laser power wireless transmission system.

In the common situation of a user blocking the beam, the interlock system should respond and bring the system to a safe state. Such operations are well described in several prior art references and patents and in the safety standards imposed by the industry, such as regulations 21CFR1040.10 in the US, and IEC60825-1 in many other countries.

As previously mentioned, the safety system should be provided with more than one interlock in order to provide backup protection should one interlock fail to provide warning of a system failure. The back-up interlock, may operate on a different physical characteristic of the laser system, to provide diversity of coverage if a circuit or component fault occurs. Additionally, a back-up interlock operating in the same way as the first interlock may also be provided.

The redundancy in the safety system thus also allows the system to remain safe when a fault happens in one interlock. However if two interlocks fail, the system is likely to become unsafe. Even though the probability of two interlocks failing at the same time is extremely low, if one of those interlocks undergoes a permanent failure and has remained in a failed state for an extended period of time, unmonitored by the diagnostic system, such as by periodic tests of the system, the system would then remain protected for a significant additional amount of time, but only by the single remaining interlock. The probability of the second interlock failing over the same extended period of time, is now higher, since the second interlock has already been operating for the entire period, up to the time that the first interlock was found to be faulty. The present diagnostic system limits the maximal time an interlock may be in a fault condition while allowing the system to remain operative, by use of a time criterion for fault finding procedures, or by means of a counting procedure, which counts how often the fault finding procedure is performed, that procedure being scheduled to operate at predetermined intervals.

Consequently, there is needed a self-diagnostic feature of the system which periodically or constantly monitors the interlocks to verify they are in good working order. This may be done, according to one embodiment of the diagnostic systems of the present application, by comparing the output result of one interlock to that of another, or of the input signals to one interlock to the input signals to another. In normal working order, the responses need to be similar, in the sense that both point at a similar hazard at a similar time, but if one interlock fails, the responses would differ, and a hazard warning should be issued and appropriate action taken.

The above described subsystem, that does the self-diagnostic test testing of the various aspects of the safety system interlocks, is called in this disclosure, a diagnostic system.

When a malfunction in the safety system is detected by the diagnostic system, the diagnostic system should bring the laser system to a safe state, such as in accordance with functional safety standards such as ISO 13849. This is generally performed by terminating the laser beam and issuing a warning signal to the user.

In particular, such a diagnostic system should also enable recovery from the safe state, and return to normal operation, in those cases where it is determined that the fault is a transient one. With such a transient fault, the diagnostic system should use at least a second interlock to ensure that when starting up the laser system again, it is operating under safe procedures. Once operating again, the diagnostic system can determine whether the transient fault has passed and the primary interlock is operational again, such that the laser system may be restarted or allowed to go to higher power without the need to wait for an external signal being given, as is the case of a permanent fault fixed by a maintenance action. This restarting procedure is thus executed without risk to users or the environment.

Transient faults may result from noise, as a result of which, a comparison of the output from a sensor with that of another sensor, or a fixed or calculated value, may result in the comparison criterion being temporarily outside the allowed boundaries defining correct functioning. This causes a transient diagnostic event to occur, causing the system to go into a safe mode. Similarly, such a situation can occur if the output of a sensor appears to stray beyond the set limits which define correct operation. These limits can be either predetermined or resulting from a calculation performed from the operating parameters of the laser system.

Other transient situations resulting from external influence on the system, such as components being exposed to temperatures outside of their operating specifications, or signals from sensors which may be influenced by light, magnetic fields, electric fields or electromagnetic waves which may temporarily alter the readings, should imply that a transient diagnostic coverage event is assumed.

Another class of such transient events may be found in software errors, where software anomalies such as race conditions between different software threads, or a random change in a bit, may cause a temporarily problem in, for instance, reading the data from a memory cell. Likewise, a warning signal from the watchdog that the CPU is malfunctioning, may be treated as a transient fault, which would be corrected at the next cyclic watchdog survey of the system, often by reloading the relevant data from storage and measuring the inputs again, or by restarting.

Transient faults may also arise from mechanical shocks to components. Thus, for instance, a mechanical vibration may temporarily “flex” an optical component from its position, without causing permanent damage. Once the external mechanical vibration has passed, the optical component will generally return to its correct position, and the transient fault will also cease.

Other examples relate to the environmental or weather conditions since changes in air pressure, humidity or dust content that may alter the optical path in the system.

In the case when the interlock may be tested without operating the laser, the system typically should do so. For example if an interlock fails or is likely to fail because the temperature of a component is too high, it may be possible to determine the current temperature of the component causing the interlock failure, or potential failure, without turning the laser on. In such a case the laser is precluded by the diagnostic system from turning on, until the temperature is back to within normal limits.

However, in many cases, it is not possible to test an interlock of a laser-based wireless power system without operating the laser. The present diagnostic system includes procedures for safely dealing with such transient fault situations by enabling the operation of the laser with limited laser power or laser time, or limiting another laser parameter in such situations, using a temporary safety system, to allow the laser to turn on safely, until the main interlock has resumed normal operation. Such a temporary safety system is typically fulfilled by the diagnostic systems described in the present disclosure.

To summarize the difference between previously existing interlock protection schemes and that of the present application, it can be noted that depending on the level of interlocks applied to the system, the laser system will be inducted into accordingly safer states.

Thus, if the laser is purposely off and is kept off, the system is inherently safe in what may be called State 1.

If the laser is on, in a low power safe state, and is kept at that low power by dual power limiting circuits, the system is fail safe, in the sense that if one of the power limiting circuits fails, the other will take over the protection, in what may be called State 2.

If the laser is on, in a high power safe state, and is kept safe by at least two interlocks preventing the user from being exposed to dangerous levels, this is a safe state typically shown in high level safety interlock systems previously described, and is what may be called State 3.

Finally, the diagnostic system of the present disclosure describes a system in which, if a fault occurs in one of the interlocks of the system providing State 3 protection, the current diagnosis system enables the system to safely test whether the faulty interlock has become operative again, even if the test may only be meaningful by operating the laser at its full power. This is achieved by applying a temporary additional interlock to ensure that at least two interlocks are operational and to allow safe testing of the faulty system at high power, this situation being called State 4.

There is thus provided in accordance with an exemplary implementation of the devices described in this disclosure, a a method for diagnostic supervision of a laser system, the laser system comprising a number of basic interlocks which enable a safety system to ensure safe transmission of laser power, the method comprising the steps of:
(i) monitoring data from sensors which provide information about the operation of the basic interlocks, for an errant output falling outside of a normal expected range of outputs, such an errant output indicating a fault in the basic interlock associated with the sensor showing the errant output;
(ii) in the event of detection of a fault in at least one basic interlock, bringing the laser system to a safe state by limiting the transmitted laser power level or by turning the laser off, and
(iii) determining from a predetermined list of fault classifications, whether the at least one interlock fault is characteristic of a permanent fault requiring external intervention to rectify, or a transient fault, expected to recede with time, wherein:
(a) if it is determined that the interlock fault is characteristic of a permanent fault, maintaining the safe state of the laser system, and
(b) if it is determined that the interlock fault is characteristic of a transient fault, temporarily applying at least one back-up interlock such that the laser is enabled to operate safely, until the fault in the at least one basic interlock has disappeared, and disabling the temporarily applied at least one back-up interlock.

In such a method, a determination as to whether the fault in the at least one basic interlock has disappeared may be performed at successive predetermined times, until the fault has disappeared. Furthermore, the at least one back-up interlock may comprise any one of maintaining the transmitted laser power at a limited level, or limiting the time that the transmitted laser power is emitted.

Additionally, in the above described methods, if, after a predetermined number of successive predetermined times, the fault in the basic interlock has not disappeared, it may be concluded that the fault in the basic interlock is not transient, but is a permanent fault. In that case, the method should provide a warning for the need for external intervention, should wait for receipt of an external indication that the fault has been corrected, and if received, should enable the laser system to return from its safe state to normal operation.

The methods above may further provide the step of precluding the laser system from going to a high output state in the event of detection of at least one basic interlock fault. Such basic interlocks may be adapted to detect malfunctions in at least one of electronic circuits, sensors, control system logic circuits, electronic components and optical components.

Furthermore, in accordance with yet another implementation of the methods of the present application, the diagnostic supervision of the laser system may comprise the step of monitoring all of the laser system basic interlocks, before determining that the fault in the basic interlock has disappeared and the laser system can operate in a high output state.

Additionally, in any of those methods, the temporarily applied at least one back-up interlock may also comprise any of:
(i) scanning the laser beam, such that it does not point in any direction for a time which may exceed a safe exposure time for the power level of the beam,
(ii) blocking or diffusing the laser beam,
(iii) attenuating the laser beam, and
(iv) directing the laser beam in a direction known to be safe.

Any of the temporarily applied back-up interlocks should be adapted to provide redundant safety in the event of detection of the fault in at least one basic interlock, such that the laser system can be operated without limitation of the transmitted laser power level.

In accordance with yet another implementation of the methods of the present disclosure, there is further provided a method for ensuring recovery from a transient fault in a main interlock of a safety system of a laser transmitter, the method comprising the steps of: switching the laser transmitter to a safe state having limited output power, applying at least one back-up interlock for performing at least one of:
(i) ensuring that the laser transmitter is in a limited power output state,
(ii) limiting the laser transmission duration to a safe level for the power output being transmitted,
(iii) scanning the laser beam to prevent impingement of the laser beam on any location for longer than a predetermined time,
(iv) blocking the laser beam from propagating,
(v) attenuating the laser beam, and
(vi) directing the laser beam into a safe direction,
   following implementation of at least one of the steps (i) to (vi), increasing laser output, and checking the correct functionality of at least the main interlock having the transient fault, and if at least the main interlock having the transient fault shows correct functionality, allowing normal full operation of the laser system,
   but if at least the main interlock having the transient fault does not show correct functionality, returning the laser system to a safe state having limited output, waiting a predetermined time, increasing the laser output and re-performing at least one of steps (i) to (vi), and repeating the step of checking the correct functionality of at least the main interlock having the transient fault.

In this method, the step of checking the correct functionality of at least the main interlock having the transient fault, may comprise:

checking that the interlock sensor is performing correctly, indicating the transient fault in the interlock has abated,
checking a logic circuit supervising the operation of the interlock, to ensure correct operation, and
checking correct functionality of a control system for bringing the laser system into a safe state.

In either of the immediately previous methods, after switching the laser transmitter to a safe state having limited output power, the system may be precluded from switching to its normal full power state. Additionally, the step of blocking the laser beam from propagating may be performed either by an opaque object, or by a diffusive object.

Furthermore, increased laser output of the laser system following implementation of at least one of the steps (i) to (vi) is allowed, since the system is now protected by at least one back-up interlock to provide redundancy in the absence of the main interlock showing a transient fault. In that situation, normal full operation of the laser system is allowed, if checking the correct functionality of at least the main interlock having the transient fault shows correct operation, since the system is now protected by at least one of the temporary back-up interlocks to provide redundancy to the main interlocks in the absence of the main interlock showing a transient fault.

Additionally, in any of these methods, if at least the main interlock having the transient fault shows correct functionality, the at least one back-up interlock may be disabled. Furthermore, in these methods, the step of checking the correct operation of the logic circuit supervising the operation of the interlock may be achieved by use of a watchdog circuit. Also, the step of checking the logic circuit supervising the operation of the interlock may achieved by observing if the sensor output is within a logical range expected from the sensor.

Finally, as clarification, the diagnostic systems described in the present disclosure use various types of secondary interlocks in order to enable the laser system to be operated for testing whether a main interlock fault has been corrected. Throughout this disclosure, such secondary interlocks may be variously termed back-up interlocks, or temporary interlocks, or redundant interlocks, or similar descriptions, and it is to be understood that all of these nomenclatures refer to the same functional interlock entities.

### BRIEF DESCRIPTION OF THE DRAWINGS

The present invention will be understood and appreciated more fully from the following detailed description, taken in conjunction with the drawings in which:

FIG. 1 shows an exemplary flow chart of the method by which the diagnostic system monitors the presence of a fault in an interlock of a high power laser system, and, after detection of such a fault, controls operations necessary for ensuring safety of the system and returning it to normal operation; and

FIG. 2 shows an exemplary flow chart of the method by which the diagnostic system safely returns a high power laser system to normal operation, when the laser system needs to operate the laser in order to achieve this return to normal operation.

### DETAILED DESCRIPTION OF THE INVENTION

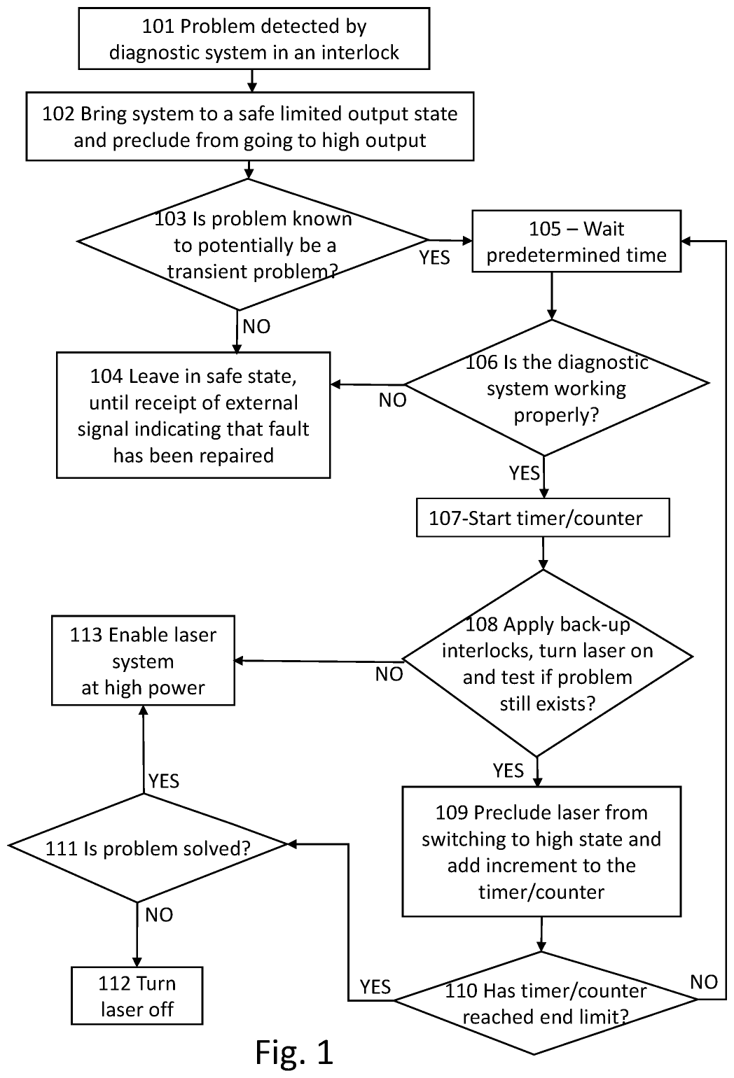

Reference is now made to FIG. 1, which illustrates schematically an overview of one exemplary method, by which the diagnostic system can be used (i) to monitor the presence of a fault in an interlock of a high power laser system, (ii) to control the operations necessary for ensuring safety of the system after detection of such a fault, and (iii) to bring the laser system back into safe operation after detection of such a fault indication, without endangering the user or anything else in the vicinity of the laser system. The normal operational state of the laser system is termed the “interlock protected state”, namely, the normally protected operation using the interlocks to warn of potentially hazardous situations arising from a fault or a user situation, until the fault is cleared, or until the user removes him/herself from the hazard situation.

In step 101, a fault in an interlock of the laser system has been detected by the diagnostic system, typically by receiving an output from a sensor or sensors, which may involve calculations of statistics, comparison between different values, comparison of values to boundaries which may be as result of a calculation of communication with an external device, the output departing by more than a limited amount from an expected level, whether the expected level is predetermined or whether the result of a calculated level from other measurements or received from an external source over a communication channel.

In step 102, because of the danger of continuing operation of the laser system when the presence of a nonfunctional interlock is suspected, the laser system is brought to a safe, limited output state, and furthermore, is precluded from switching to its regular output operational state.

In step 103, the diagnostic system controller then determines whether it is suspected that the dissident reading arises from a potentially transient problem, such as excessive noise level, or a temperature extreme, or a noise in the electronic environment, or another external issue. This determination usually involves comparing whether the parameters of the dissident reading match a specific criterion, usually predefined, which is known to possibly indicate transient problems, but is also not linked to failures which may cause common permanent failures of multiple subsystems related to safety. This step is a predictive estimate, since all that the diagnostic system knows is that a rogue reading has been obtained, and the true source has now to be determined. The initial determination can be made by reviewing whether the fault detected is compatible with faults enumerated on a database list of predetermined problems that are often found to be transient problems. If the particular fault detected cannot be matched with a fault on that list, it is assumed that the fault is not indicative of a transient problem, and is likely to be a “permanent” fault, in the sense that it will not disappear without intervention.

In step 104, the diagnostic controller then maintains the laser system in the safe limited output state or even turns the laser off for certain types of fault that may recommend that action, and a warning signal may be generated to the effect that external intervention is required. Optionally, a service call is also activated, such that the repair or maintenance work can be undertaken. Meanwhile, the diagnostic system controller continues to preclude the laser system from switching to its regular output, or even continues to maintain the laser closed down so that no laser output is generated. This state is maintained until an external signal is received in the diagnostic system controller, from the service or maintenance staff, or from an automatic external system, such as a cleaning robot or a software patch, to indicate that the fault has now been fixed, and the laser system can then revert to its normal operation in step 104.

If, on the other hand, in step 103, the fault concerned is indicated by the database list or by a programming routine of the system, to be likely associated with a transient problem, then in step 105, the system is maintained in its safe, limited output state, or even with the laser turned off, for a predetermined time. This then provides an additional pointer to the determination as to whether the fault is a fixed fault or whether it is a transient fault, by observing, after waiting for the predetermined time in step 105, whether the dissident reading remains at an unacceptable level, which may be indicative of a permanent fault having arisen in the system, or if the dissident reading changes, which may indicate a temporary problem arising because of an external, and hence fluctuating, influence on a component, or on a circuit, or on a measurement device, or on a sensor, or the like.

After waiting for the predetermined time in step 105, before proceeding with the process of ascertaining whether the transient problem has passed, the operational status of the diagnostic system should be checked in step 106, to ensure that it is monitoring all of the required parameters of the laser system interlocks correctly. Thus, for instance, the testing of the output of a suspected sensor generating an out-of-range reading, against a known and valid reference level, will confirm whether or not the suspected sensor and its dependent interlock have returned to a correct operational condition.

In step 106, if it is found that the diagnostic system itself may not be functioning correctly, it is considered dangerous to continue with procedures for determining when the transient fault of the laser system has passed-if it is indeed a transient fault—and the controller reverts the system to step 104, and waits in a safe state or the OFF state until a confirmation is received in step 104 that the fault has been repaired.

On the other hand, if in step 106, confirmation has been received that the diagnostic system is in a correct operational state, then in step 107, a system counter is started. The counter function is to keep track of the number of times or the number of time increments that have passed while such fault test is being repeatedly performed. The counter may be either a counter determining the number of iterative attempts that have been made to determine whether the fault has been cleared, or it can be a timed counter, incrementing sequentially at fixed time intervals, as determined in step 105, in which case the “counter” will be a timer, measuring the elapsed time since which the fault test has been applied in the previous sequential test cycle.

Since in step 106, the diagnostic system was deemed to be operative and hence, the system is being safely monitored, in step 108, additional back-up or redundant interlocks are implemented, and the laser power can be increased, with the knowledge that the interlocks, both primary and back-up, are in correct working order, and are being applied while the laser power level is being raised. A test as to whether the original fault is still present can thus be performed. These back-up or redundant interlocks could, for instance, be the operation of the laser, either at a reduced power level, or for a limited duration of time, such that the exposure to the laser beam is limited to be within accepted safe conditions. Any other interlocks which ensure that the emitted beam does not present a hazard, such as rapidly scanning the beam, or blocking the beam, or activating a beam attenuator or diffuser, or directing the beam into a safe direction, may also be applied as back-up interlocks to ensure safe operation of the laser as its power is raised. With the laser operating, the diagnostic system now has the opportunity to determine whether the system fault problem still exists, such as by determining if the dissident reading still departs from the limits of its expected level.

If in step 108, it is determined that there is no indication that the fault problem has been solved, then in step 109, the laser is turned back down to a limited output state, or is turned off completely, and is precluded from switching to a high state, and the counter or timer is advanced, to indicate that another system testing cycle has been performed. Since there should be a limited number of test cycles performed, to avoid infinite testing iterations, then in step 110, the system interrogates the counter/timer system to ascertain whether the maximum number of cycles has been performed. If not, then the method reverts back to step 105, waits the predetermined time and begins the testing cycle procedure again from step 106 onwards. If the maximum number of test cycles has been performed, then in step 111, the system is interrogated to determine whether the fault has been cleared, and if not, it is assumed that the fault is a permanent fault, and the laser is turned off in step 112, to await a technical repair, as in step 104.

If, on the other hand, in step 108, the method determines that there is positive indication that the problem has been solved, even before the maximum number of iterations has been executed, then the diagnostics system no longer precludes the laser from operating at its full power, though the interlocks or the operational parameters of the system, may still preclude it from doing so, depending on other parameters unrelated to the fault discovered in the system and now remedied. The system is thus considered to be fully operational again, such that operation of the back-up interlocks can now cease, and in step 113, the laser system is enabled at its full power.

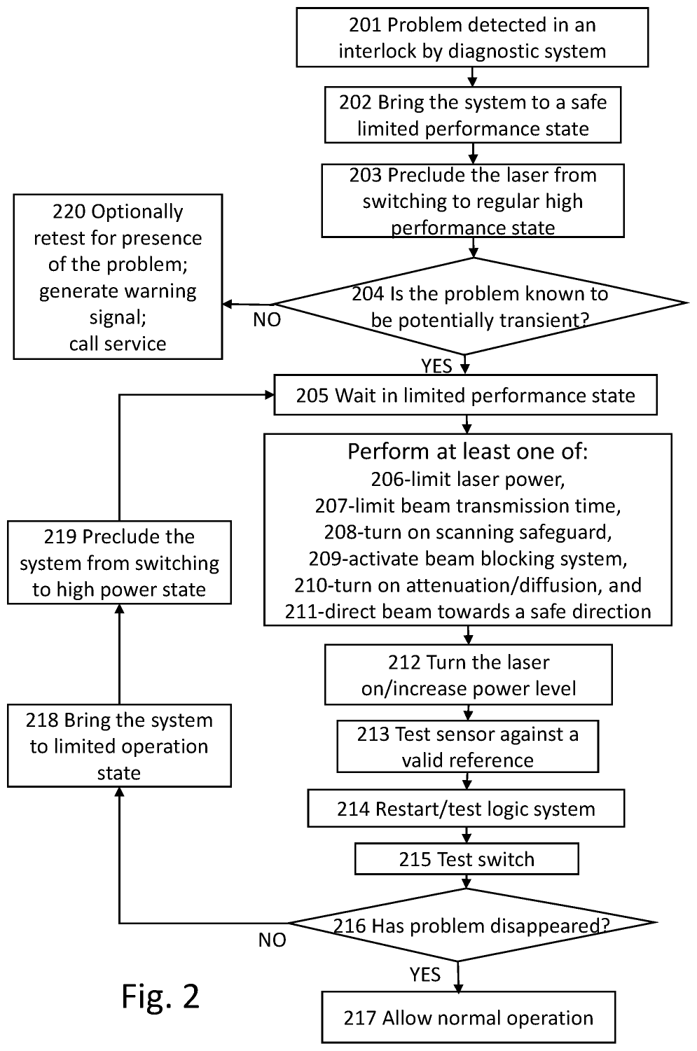

Reference is now made to FIG. 2, which illustrates schematically, one exemplary method by which the diagnostic system operates to safely test whether a transient fault in a main interlock has passed, and the interlock has returned to its normal monitoring function, thereby enabling the laser system to resume its full capabilities.

In step 201, the diagnostic system determines that a fault problem has been detected in a main interlock, typically by receiving an output from a sensor or sensors and comparing the level of the output to a limit, whether predetermined or calculated.

In step 202, after detection of a fault based on the result of the test in step 201, the system is brought to a safe state, either having a limited output level, or with the laser turned off. The system must have at least one safe state, and at least one state whose safety is assured by the interlock system, but which would not be safe without a sufficient number of interlocks operating.

Then in the safe state, in step 203, the system is precluded from going into the “interlock protected state”, i.e. normally protected operation using the main interlocks to warn of potentially hazardous situations, until the fault is cleared.

In step 204, the diagnostic system controller inspects whether the problem found is in a database list of predetermined problems that may be transient faults. If the problem is not on the “transient list”, it is assumed that it is of a more permanent nature, and requires external intervention to solve. The diagnostic system, in step 220, may optionally wait a predetermined time, and then raise the laser power for a brief time, shorter than would involve exceeding the allowed exposure limit of the beam, to test whether or not the fault still exists. If the fault is still present, or if the previously mentioned fault confirmation test was not performed, a warning about the likely permanent nature of the fault is issued, and the laser system is continued to be precluded from switching to the high power status of the “interlock protected state”, until an external event, such as maintenance or user attention, occurs.

Only if the fault is identified in step 204 as being potentially transient, does the system wait in step 205 for a predetermined time in the safe, limited performance state, or in the OFF state if so entered, and then performs at least one of the following operations, all of which are operative as back-up interlocks to ensure safety while a main interlock is faulty, before enabling the laser to be turned back into its full power output capability:
206 Limiting the laser output power.
207 Limiting the time duration that the laser is allowed to emit its beam.
208 Constantly changing the alignment direction of the beam unit, such as by performing a scanning motion procedure, so that the laser is not pointing in one direction for a time which may exceed the safe exposure time for that power level.
209 Blocking the beam by an opaque object or diffusing the collimated beam by a diffusive object.
210 Attenuating the beam.
211 Directing the beam in a direction towards a known safe beam absorbing target, or a beam block, or into a direction where it is known that the beam cannot be harmful.

In step 212, once at least one of the previous steps 206 to 211 have been implemented, the laser can now be turned on at its increased power level, namely the interlock protected state is now implemented, since the system is now protected by at least one of the temporary back-up interlocks of steps 206 to 211, to provide redundancy to the main interlocks in the absence of the faulty main interlock.

Now that at least one of these safeguards is in place, the diagnostic system typically performs a series of tests, to ensure that each interlock is operative in all aspects of its functionality. The tests can advantageously comprise assessment of the following three aspects of the interlock functionality:
(a) a sensor function, such as, for instance a temperature monitor, which would be checked by comparing its values to another test result of the temperature;
(b) a logic function, such as determining whether the indicated temperature is outside the conceivable range for that measurement, the logic functionality generally being tested by a watchdog; and
(c) an output function, such as for instance, the action of turning the laser off, which could be tested by trying to turn the laser off to see whether the output function is operative.

Applying this process to the method of FIG. 2, the following steps would be taken:

In step 213, a test is performed to ensure that the previously faulty interlock sensor, designed to provide indication of risk, is performing correctly, typically by measuring a sensor response, such as for instance, a temperature monitor output, against a reference response.

In step 214 a test is performed to determine whether the overall interlock functional parts are operating correctly in providing logically acceptable results, namely whether the sensor and sensor output are operating correctly, and whether the logic circuit or analog circuit performing “logic operation” (“logic” can be a simple comparison of a value to a threshold) is functional, typically using a watchdog on the controller, and detecting whether the output function of the circuit is functional.

In step 215, a test is performed to determine whether the switch or control function allowing the system to be brought to a safe state, is operating correctly. This is known to be true at this stage, since the system is already in a safe state, but a procedural situation could arise that would make this test necessary.

All the above three tests are checked in step 216, and if the problem is found to have passed or corrected automatically, then in step 217, the diagnostic system controller provides an instruction to enable the laser system to resume normal operation at up to its full power output, and the temporary back-up interlock applied in steps (i) to (vi) can be disabled.

On the other hand, if in step 216, it is determined that any of the tests 213, 214, 215, are unsuccessful, and that the fault problem has not subsided, the system is limited to a low power state in step 218, and is precluded in step 219, from switching to its normal operational state, and the diagnostic control algorithm returns the system to step 205, where the system is instructed in to wait in its limited performance state before again commencing the safety process of steps 206 to 216.

To illustrate the above described procedures, an example scenario of how a diagnostic system may operate in an exemplary real-life situation uses an exemplary wireless power laser system protected against inadvertent intrusion by a user, by means of two main or basic interlocks, both of which are known in previously described systems. The first interlock is an intrusion detection system using an optical sensor such as a camera, to detect when a person moves close to or within the beam path. The second interlock is a “power accounting system”, which compares the power emitted from the laser to the power received by the receiver, to determine if the amount of power lost during transmission exceeds a limit which could indicate an intrusion into the beam.

The system includes an interlock diagnostic system of the kind described in this disclosure, capable of monitoring a number of fault situations.

Some typical faults, which the diagnostic system of the present application can handle, are now described. For the camera-based system, if the image is completely black, white, gray, or has white noise or static interference, a camera interlock problem is indicated.

If the watchdog for the controller processing the image is not regularly resettled, a further problem is indicated.

An additional problem could be that the switching controller or circuits used to turn the laser off, are not functioning correctly. This could be tested by periodically turning the laser off.

For the power accounting system, when the power measured by the power output meter of the transmitter does not match the laser power expected from the laser controller power settings, or when the system controller's watchdog is not periodically resettled, or when the switch used to turn the laser off is not working, there would be a diagnostic fault indication. Upon receiving any such indication, the system would be switched to a limited performance, safe state. There is usually at least one additional switch for performing this function, such that the loss of a first switch functionality, does not render the system as being under-protected.

If one switch or its control circuit, intended to allow the system to turn the laser off, is non-functional, this fault would not generally be considered a transient problem, and the system would thus be permanently kept from switching to the interlock protected, normal power state, until an external event takes place, such as a maintenance intervention procedure. In such a situation, the diagnostic system would keep the laser off typically using another switch.

If the controller watchdog is not being reset periodically, then the controller should be restarted, which may solve the problem. Such a restarting operation should be performed without turning the laser on

If the camera shows a defective image, such as was described hereinabove, it should be retested, optionally without turning the laser on.

As another example of the diagnosis system of the present disclosure, one particular fault that should require more specific action, is that of a power meter indicated as being faulty. In such a situation, the system would preferably perform an exemplary procedure, such as:
(i) A temporary limit is placed on the laser output, typically either an exposure time limit, or a power limit, or the application of a scanning operation, any of which ensures that the laser does not exceed safety exposure limits.
(ii) A test is performed on the power meter, obviously with the laser beam on. Because of the need for adhering to the safe exposure limits, the test has to be performed within a limited time, to limit the laser beam exposure time accordingly.
(iii) If the test does not indicate that the power meter is in good working order, the system is brought back to a safe state again, and after a predetermined time, during which it may be expected that if the power meter problem is a transient fault, it will have subsided during the predetermined time, the procedure of steps (i) to (iii) is repeated.
(iv) Only if the power meter is tested as “operational”, may the laser system resume normal operation, assuming that everything else is in order.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. Furthermore, it is appreciated by persons skilled in the art that the present invention is not limited by what has been particularly shown and described hereinabove. Rather the scope of the present invention includes both combinations and subcombinations of various features described hereinabove as well as variations and modifications thereto which would occur to a person of skill in the art upon reading the above description and which are not in the prior art.

1. A method for diagnostic supervision of a laser system, the laser system comprising a number of basic interlocks which enable a safety system to ensure safe transmission of laser power, the method comprising the steps of:
monitoring data from sensors which provide information about the operation of the basic interlocks, for an errant output falling outside of a normal expected range of outputs, such an errant output indicating a fault in the basic interlock associated with the sensor showing the errant output;
in the event of detection of a fault in at least one basic interlock, bringing the laser system to a safe state by limiting the transmitted laser power level or by turning the laser off; and
determining from a predetermined list of fault classifications, whether the at least one interlock fault is characteristic of:
(i) a permanent fault requiring external intervention to rectify, or
(ii) a transient fault, expected to recede with time;
wherein:
(a) if it is determined that the interlock fault is characteristic of a permanent fault, maintaining the safe state of the laser system; and
(b) if it is determined that the interlock fault is characteristic of a transient fault, temporarily applying at least one back-up interlock such that the laser is enabled to operate safely, until the fault in the at least one basic interlock has disappeared, and disabling the temporarily applied at least one back-up interlock.

2. The method according to claim 1, wherein a determination as to whether the fault in the at least one basic interlock has disappeared is performed at successive predetermined times, until the fault has disappeared.

3. The method according to either of claims 1 and 2, wherein the at least one back-up interlock comprises any one of maintaining the transmitted laser power at a limited level, or limiting the time that the transmitted laser power is emitted.

4. The method according to any of the previous claims, wherein, if after a predetermined number of successive predetermined times, the fault in the basic interlock has not disappeared, concluding that the fault in the basic interlock is not transient, but is a permanent fault.

5. The method according to any of the previous claims, wherein if it is determined that the fault is characteristic of a permanent fault, providing a warning for the need for external intervention, waiting for receipt of an external indication that the fault has been corrected, and if received, enabling the laser system to return from its safe state to normal operation.

6. The method according to any of the previous claims, further providing the step of precluding the laser system from going to a high output state in the event of detection of at least one basic interlock fault.

7. The method according to any of the previous claims, wherein the basic interlocks are adapted to detect malfunctions in at least one of electronic circuits, sensors, control system logic circuits, electronic components and optical components.

8. The method according to any of the previous claims, wherein the diagnostic supervision of the laser system comprises the step of monitoring all of the laser system basic interlocks, before determining that the fault in the basic interlock has disappeared and the laser system can operate in a high output state.

9. The method according to any of the previous claims, wherein the temporarily applied at least one back-up interlock further comprises any of:
scanning the laser beam, such that it does not point in any direction for a time which may exceed a safe exposure time for the power level of the beam;
blocking or diffusing the laser beam;
attenuating the laser beam; and
directing the laser beam in a direction known to be safe.

10. The method according to any of the previous claims, wherein the temporarily applied at least one back-up interlock is adapted to provide redundant safety in the event of detection of the fault in at least one basic interlock, such that the laser system can be operated without limitation of the transmitted laser power level.

11. A method for ensuring recovery from a transient fault in a main interlock of a safety system of a laser transmitter, the method comprising the steps of:
switching the laser transmitter to a safe state having limited output power;
applying at least one back-up interlock for performing at least one of:
(i) ensuring that the laser transmitter is in a limited power output state;
(ii) limiting the laser transmission duration to a safe level for the power output being transmitted;
(iii) scanning the laser beam to prevent impingement of the laser beam on any location for longer than a predetermined time;
(iv) blocking the laser beam from propagating;
(v) attenuating the laser beam; and
(vi) directing the laser beam into a safe direction;
following implementation of at least one of the steps (i) to (vi), increasing laser output, and checking the correct functionality of at least the main interlock having the transient fault; and
(a) if at least the main interlock having the transient fault shows correct functionality, allowing full operation of the laser system; but
(b) if at least the main interlock having the transient fault does not show correct functionality, returning the laser system to a safe state having limited output, waiting a predetermined time, increasing the laser output and re-performing at least one of steps (i) to (vi), and repeating the step of checking the correct functionality of at least the main interlock having the transient fault.

12. The method according to claim 11, wherein the step of checking the correct functionality of at least the main interlock having the transient fault, comprises:
checking that the interlock sensor is performing correctly, indicating the transient fault in the interlock has abated;
checking a logic circuit supervising the operation of the interlock, to ensure correct operation; and
checking correct functionality of a control system for bringing the laser system into a safe state.

13. The method according to either of claims 11 and 12, wherein after switching the laser transmitter to a safe state having limited output power, the system is precluded from switching to its normal full power state.

14. The method according to any of claims 11 to 13, wherein the step of blocking the laser beam from propagating is performed either by an opaque object, or by a diffusive object.

15. The method according to any of claims 11 to 14, wherein increased laser output of the laser system following implementation of at least one of the steps (i) to (vi) is allowed, since the system is now protected by at least one back-up interlock to provide redundancy in the absence of the main interlock showing a transient fault.

16. The method according to claim 15, wherein normal full operation of the laser system is allowed, if checking the correct functionality of at least the main interlock having the transient fault shows correct operation, since the system is now protected by at least one of the temporary back-up interlocks to provide redundancy to the main interlocks in the absence of the main interlock showing a transient fault.

17. The method according to any of claims 11 to 16, wherein if at least the main interlock having the transient fault shows correct functionality, the at least one back-up interlock may be disabled.

18. The method according to any of claims 11 to 17, wherein the step of checking the correct operation of the logic circuit supervising the operation of the interlock is achieved by use of a watchdog circuit.

19. The method according to any of claims 11 to 17, wherein the step of checking the logic circuit supervising the operation of the interlock is achieved by observing if the sensor output is within a logical range expected from the sensor.
